(19) United States
(12) Patent Application Publication
(10) Pub. No.: US 2013/0166684 A1
(43) Pub. Date: Jun. 27, 2013

(54) APPARATUS AND METHOD FOR PROVIDING PARTIAL CONTENTS

(71) Applicant: KT CORPORATION, Seongnam (KR)

(72) Inventors: Heui-Cheol PARK, Seongnam-si (KR); Jae-Cheol KWON, Daejeon (KR); Bae-Keun LEE, Seongnam-si (KR); Sun-Young CHO, Seoul (KR)

(73) Assignee: KT CORPORATION, Seongnam (KR)

(21) Appl. No.: 13/727,168

(22) Filed: Dec. 26, 2012

(30) Foreign Application Priority Data
Dec. 22, 2011 (KR) 10-2011-0140631

(51) Int. Cl. H04L 29/06

(52) U.S. Cl. CPC H04L 65/4069
USPC 709/217

(57) ABSTRACT

An apparatus includes a contents identifier configured to identify contents displayed on a first device among a plurality of devices, a usage history monitor configured to monitor usage history of a second device among the plurality of devices, a partial contents generator configured to generate partial contents, which is a part of the contents, based on the monitored usage history and a partial contents transmitter configured to transmit the partial contents to any one of the plurality of devices.

### CROSS-REFERENCE TO RELATED PATENT APPLICATION

This application claims priority from the Korean Patent Application No. 10-2011-0140631, filed on Dec. 22, 2011 in the Korean Intellectual Property Office, the entire disclosure of which is incorporated herein by reference.

### BACKGROUND

1. Field

Apparatuses and methods consistent with exemplary embodiments broadly relate to an apparatus and a method for providing partial contents

2. Description of the Related Art

As types of mobile devices are diversified and popularized, the number of devices possessed by an individual user is increasing. By virtue of the characteristic of a mobile device that makes it easy to carry, personal users can use contents regardless of a distance from home or work, a time, and a location. However, there have been restrictions in seamlessly viewing contents being viewed in a device, in another device. Thus, there has been a demand for a technology for reproducing identical contents in various types of multiple devices, and a technology for seamlessly reproducing contents being reproduced in one of multiple devices, in another device of the multiple devices. With respect to a method for seamlessly viewing contents in different devices, Korean Patent Application Publication No. 2011-0009587 describes a method for seamlessly viewing video contents between different devices.

In general, a mobile communication network used in a mobile device has a relatively slow transmission speed, compared to a wired network or a wireless Wi-Fi network connected to a personal computer (PC). When viewing high definition contents, a user may experience inconvenience in viewing the contents due to the relatively slow transmission speed. As the number of contents increases, a user cannot enjoy all the contents. Even in case of specific contents, there has been increasing tendency to view contents based on a user's specific interest, rather than viewing the contents from start to finish. Accordingly, a method for stably providing a user with contents having a specific part of interest to a user, by dividing and providing certain parts of interest to different users among contents provided to devices of the users, is being demanded.

### SUMMARY

Accordingly, it is an aspect to provide an apparatus and a method for providing partial contents, by identifying contents displayed on one device of multiple devices, and monitoring usage history of another device of the multiple devices.

According to an aspect of exemplary embodiments, an apparatus includes an identifier configured to identify contents displayed on a first device among a plurality of devices, a monitor configured to monitor usage history of a second device among the plurality of devices, a generator configured to generate partial contents, which are a part of the contents, based on the monitored usage history and a transmitter configured to transmit the partial contents to at least one device among the plurality of devices.

At least two of the plurality of devices may belong to a same user, and the usage history of the second device may be monitored during reproduction of the contents displayed on the first device.

The second device may be located substantially close in proximity to the first device.

The usage history may be monitored by using at least one from among data input to the second device and data output from the second device.

The usage history may comprise a variation of a data usage amount associated with a service provided to the second device. The service may be preset.

The contents may comprise broadcasting stream contents, and the usage history of the second device may comprise at least one from among: one of an increasing history and decreasing history of social network service (SNS) data; one of an increasing history and decreasing history of message data; one of an increasing history and decreasing history of call data; and one of an increasing and decreasing history of keyword search data.

The partial contents may be extracted from the contents starting at an extraction time, and the partial contents may comprise information about the extraction start time.

The usage history may comprise user comments associated with the contents.

The partial contents may be generated based on at least one from among a time point when the user comments increase, a time point when the user comments reach a maximum amount, and a time point when the user comments decrease.

The partial contents may be generated depending on whether the user comments are one from among favorable and unfavorable. The partial comments may comprise the user comments.

The transmitter may be further configured to receive a request signal from one device of the plurality of devices, and transmit the partial contents to said one device. The request signal may comprise a request for the partial contents.

The transmitter may be further configured to select at least one from among a plurality of partial contents based on a type of said one device, and transmit the selected at least one from among the plurality of partial contents to said one device.

The selected at least one from among the plurality of partial contents comprises ranking information of the selected at least one from among the plurality of partial contents.

The transmitter may be configured to further transmit, to said one device, recommended contents associated with one from among the contents and the partial contents.

The transmitter may be further configured to transmit the partial contents to another device whose owner is different from the same user.

The monitor may be further configured to receive usage history of the second device from a usage history management apparatus. The usage history management apparatus may be provided one of separate from or within the apparatus.

Partial contents related to favorable user comments may be different in color from partial contents related to unfavorable user comments.

According to another aspect of exemplary embodiments, a method includes identifying contents displayed on a first device among a plurality of devices, monitoring usage history of a second device among the plurality of devices, generating partial contents, which is a part of the contents, based on the monitored usage history and transmitting the partial contents to at least one from among the plurality of devices.

The operations of identifying, monitoring, generating, and transmitting may be sequentially performed in order.

An apparatus includes an identifier configured to identify contents displayed on a first device among a plurality of devices, a detector configured to detect data transmitted to and received from a second device among the plurality of devices, a collector configured to collect usage history of the second device associated with the identified contents based on the detected data and a transmitter configured to transmit the collected usage history to a contents providing apparatus, wherein the transmitted usage history is used for generating partial contents from the contents.

According to yet another exemplary embodiment, there is provided a system for providing contents and partial contents, the system comprising: a first device for providing partial contents to a receiving device, the first device comprising: a monitor configured to monitor usage history of a second device among the plurality of devices; and a generator configured to generate the partial contents, which is a part of the contents, based on the monitored usage history; and a second device comprising: an identifier configured to identify contents displayed on a first user device among a plurality of user devices; and a detector configured to detect data transmitted to and received from a second user device among the plurality of user devices.

In exemplary embodiments, it can provide a user with necessary information and reduce traffics of networks by abstracting parts interested by many users to provide partial contents thereof.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a view illustrating a configuration of a partial contents providing system according to an exemplary embodiment;

FIG. 2 is a block diagram illustrating a partial contents providing apparatus according to an exemplary embodiment;

FIG. 3 is a flow diagram illustrating a partial contents providing method according to an exemplary embodiment;

FIG. 4 is a flow diagram illustrating a partial contents providing method according to another exemplary embodiment;

FIG. 5 is a block diagram illustrating a usage history management apparatus according to an exemplary embodiment; and

FIG. 6 is a flow diagram illustrating a partial contents providing method according to another exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

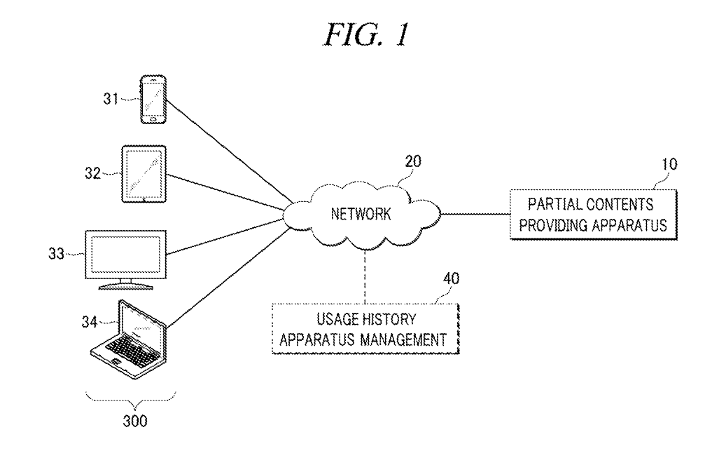

FIG. 1 is a view illustrating a configuration of a partial contents providing system according to an exemplary embodiment. With reference to FIG. 1, the partial contents providing system includes a partial contents providing apparatus 10, multiple devices 300 connected to the partial contents providing apparatus 10 through a network 20, and a usage history management apparatus 40, which can be provided separately.

The network 20 means a connection structure enabling information exchange between nodes such as devices and servers, and includes networks such as the Internet, a local area network (LAN), a wireless local area network (Wireless LAN), a wide area network (WAN), a personal area network (PAN), and a mobile radio communication network. However, the exemplary embodiments are not limited thereto.

The multiple devices 300 may be realized by mobile devices that can access a remote server through a network. Here, the mobile devices are mobile communication devices assuring portability and mobility. For example, the mobile devices may include any types of handheld based wireless communication devices such as a personal communication system (PCS), a global system for mobile communication (GSM), a personal digital cellular (PDC), a personal handyphone system (PHS), a personal digital assistant (PDA), an international mobile telecommunication (IMT)-2000, code division multiple access (CDMA)-2000, W-code division multiple access (W-CDMA), a wireless broadband Internet (Wibro) device, and a smart phone.

The multiple devices 300 may include devices connected through a network such as an Internet protocol TV (IPTV) set-top box and a PC. However, the devices illustrated in FIG. 1 are merely exemplary for convenience of description. The devices of the exemplary embodiments should not be construed as being limited to those illustrated in FIG. 1.

The partial contents providing apparatus 10 can identify contents displayed on a first device among the multiple devices 300. Also, the partial contents providing apparatus 10 can identify contents displayed on any one of multiple devices belonging to the same user. For example, when a user is using broadcasting contents through an IPTV or viewing a video contents through a smart phone among multiple devices possessed by the user, the partial contents providing apparatus 10 can identify the broadcasting contents being reproduced or the video being reproduced.

The partial contents providing apparatus 10 can monitor usage history from a second device among the multiple devices 300. The second device may be located close in proximity to the first device. The usage history of the device may include a variation of the data usage amount associated with a preset service provided to the second device. The partial contents providing apparatus 10 can monitor the usage history of the second device by using at least one from among data input to the second device and data output from the second device.

During reproduction of the contents on the first device, the partial contents providing apparatus 10 may monitor usage history of another device. The contents may include broadcasting stream contents, and the first device may reproduce the broadcasting stream contents. The usage history of the second device may include at least one of increase or decrease history of social network service (SNS) data, increase or decrease history of message data, increase or decrease history of call data, and increase or decrease history of keyword search data and others, or increase or decrease history of user comments associated with the contents.

The partial contents providing apparatus 10 may collect the usage history of the second device through a usage history management apparatus 40 that can be separately provided (or provided within the partial contents providing apparatus 10), and receive the usage history from the usage history management apparatus 40 to monitor the usage history of the second device.

Based on the monitored usage history, the partial contents providing apparatus 10 may generate, from the contents, partial contents, which are parts of the contents (e.g., a portion of the contents over a particular period of time). The partial contents is extracted from the contents starting at an extraction start time of the contents, and may include information about the extraction start time. The partial contents providing apparatus 10 may generate the partial contents based on at least one of a time point when the user comments increase, a time point when the user comments reach a maximum amount, and a time point when the user comments decrease. The partial contents providing apparatus 10 may generate the partial contents depending on whether the comments are favorable or unfavorable. The generated partial contents may include the user comment.

The partial contents providing apparatus 10 may receive, from one device of the plurality of devices, a partial contents request signal, and provide the partial contents to the one device. The partial contents providing apparatus 10 may select any one of the multiple partial contents based on a type of the one device requesting the partial contents, and provide the selected partial contents to the one device. The selected partial contents may include ranking information of the selected partial contents.

The partial contents providing apparatus 10 may further transmit, to any one device, recommended contents in association with the contents or the partial contents, together with the partial contents. Also, the partial contents providing apparatus 10 may transmit the partial contents to another device of which an owner is different from the same user of some of the plurality of devices.

The operation of the partial contents providing apparatus 10 will be described in detail below.

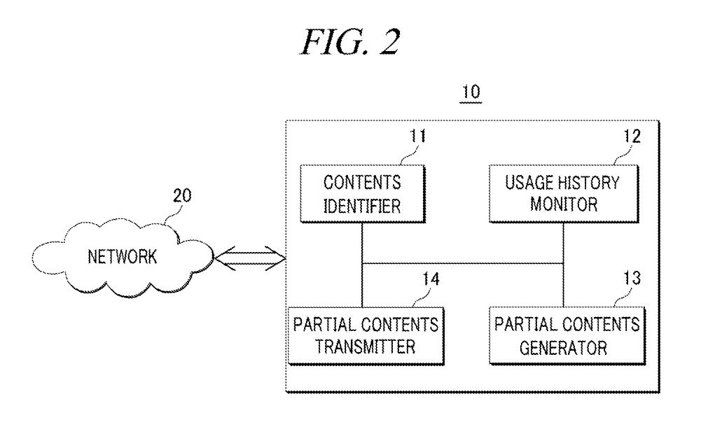

FIG. 2 is a block diagram illustrating a partial contents providing apparatus according to an exemplary embodiment. With reference to FIG. 2, the partial contents providing apparatus 10 includes a contents identifier 11, a usage history monitor 12, a partial contents generator 13, and a partial contents transmitter 14. The partial contents providing apparatus may also include a memory and a central processing unit (CPU) for performing the operations described herein with respect the partial contents providing apparatus. However, it can be understood by those skilled in the art that various modifications can be made based on the components illustrated in FIG. 2.

The contents identifier 11 may identify contents displayed on a first device among multiple devices. The contents may be a broadcasting stream contents. The first device may be a device that reproduces the broadcasting stream contents. Also, the contents identifier 11 may identify contents displayed on a first device among multiple devices belonging to a same user. For example, when a first user is using a broadcasting service through an Internet protocol TV (IPTV), and second user is using the broadcasting service through a smart phone belonging to the first user, the contents identifier can identify that a user is using the broadcasting service by using a TV or a smart phone.

The usage history monitor 12 may monitor usage history of a second device among multiple devices. Also, the usage history monitor 12 may monitor the usage history of the second device during reproduction of the contents on the first device. The usage history monitor 12 may monitor the usage history of the second device by using at least one from among data input to the second device and data output from the second device. The second device may be located close in proximity to the first device. The usage history includes a variation of a data usage amount associated with a preset service provided to the second device, and may comprise at least one of increase or decrease history of social network service (SNS) data, increase or decrease history of message data, increase or decrease history of call data, and increase or decrease history of keyword search data. The usage history may include user comments associated with the contents.

For example, the usage history monitor 12 may monitor the usage history of the device by using a variation of the data usage amount of the device such as an evaluation of a main character through a SNS while watching a drama through the IPTV, registration of user comments on a news article with SNS, an increase in the amount of individuals' encouraging user comments while viewing a game broadcasting, an increase of telephone orders while watching a home shopping show, or a decrease of messages or call amounts in peripheral cells of a sport's stadium while people visiting to the stadium are concentrating on a game match.

The usage history monitor 12 may provide the usage history management apparatus 40 that can be provided separately from the partial contents providing apparatus 10 (or within the partial contents providing apparatus), to collect the usage history of the second device, and receive the collected usage history from the usage history management apparatus.

Based on the monitored usage history, the partial contents generator 13 may generate, from the contents, partial contents, which is a part of the contents. The partial contents is extracted from the contents starting at an extraction start time, and may include information about the extraction start time. The partial contents may be highlighted parts of a sport's game match such as a football or a baseball, or a memorable scene in a drama or a movie.

The partial contents generator 13 may generate the partial contents based on at least one of a time point when the user comments associated with contents increase, a time point when the user comments reach a maximum amount, and a time point when the user comments decrease. The partial contents generator 13 may generate the partial contents depending on whether the user comments are favorable or unfavorable. The partial contents may include the user comments. For example, partial contents for favorable user comments may be indicated in a green color, and contents for unfavorable user comments may be indicated in a red color. With regard to the contents, the partial contents may be partial at a time point of 1 or 2 minutes prior to a time point when user comments begin to increase until a time point when the user comments reach a maximum point and begin to decrease, or until a time point when a scene change occurs through video image processing.

The partial contents transmitter 14 may transmit the partial contents to any one of the multiple devices. In other words, the contents transmitter 14 may receive a partial contents request signal from one device, transmit the partial contents to the one device by selecting any one of the partial contents based on a type of the one device. The selected partial contents may include ranking information of the contents. For example, if a user requests partial contents, the partial contents transmitter 14 may recognize a type of the device that has requested the contents, such as an IPTV, a smart phone, and a PC, select a partial contents to be transmitted to the device depending on a type of the device, and transmit the selected partial contents to the device.

The partial contents transmitter 14 may further transmit, to any one device, recommended contents associated with the contents or the partial contents, together with the partial contents. Also, the partial contents transmitter 14 may transmit the partial contents to any one of multiple devices belonging to another user. For example, if a device requesting contents is an IPTV or a PC, the partial contents transmitter 14 may provide all contents, partial information, and evaluation on the contents. If a device requesting contents is a smart phone, the partial contents transmitter 14 may provide only partial contents including mostly favorable user comments, which may be indicated in a green color, or partial contents including mostly unfavorable user comments, thus being indicated in a red color, or provide only high ranking partial contents. The partial contents transmitter 14 may expose essential keywords regarding an evaluation by a user. Upon a further request by a user, the partial contents transmitter 14 may further expose all contents and evaluations, in order to identify the entire contents and evaluation. Also, the partial contents transmitter 14 may associate the partial contents with evaluation information such as favorable user comments and unfavorable user comments to expose recommended contents for associated contents.

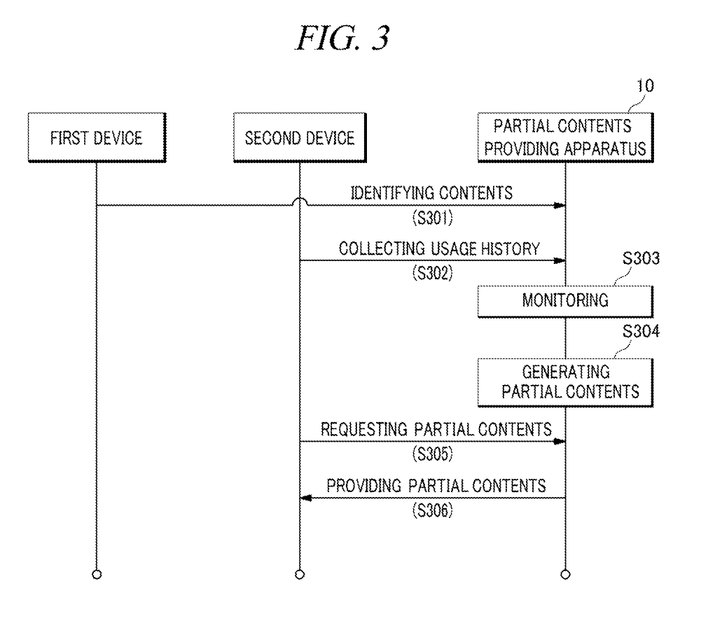

FIG. 3 is a flow diagram illustrating a partial contents providing method according to an exemplary embodiment. With reference to FIG. 3, the partial contents providing apparatus 10 identifies contents displayed on the first device (S301), and collects, from the second device, usage history of the device (S302). The partial contents providing apparatus 10 monitors the usage history collected from the second device (S303). Based on the usage history, the partial contents providing apparatus 10 generates partial contents by abstracting the contents until a part of the contents on which many users' comment, are provided, or a time point when a scene change occurs (S304). The partial contents providing apparatus 10 receives a request signal for requesting partial contents from the second device (S305). The partial contents providing apparatus 10 provides the partial contents to the second device that has requested the partial contents (S306).

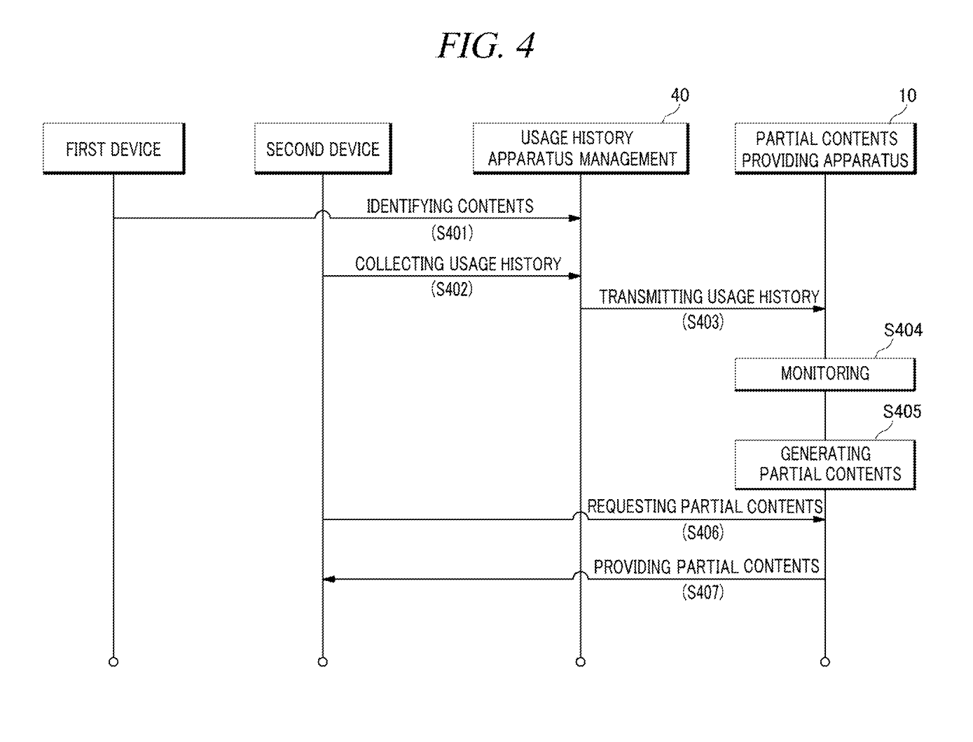

FIG. 4 is a flow diagram illustrating a partial contents providing method according to another exemplary embodiment. With reference to FIG. 4, the usage history management apparatus 40 identifies contents displayed on the first device (S401), and collects, from the second device, usage history of the device (S402). The usage history management apparatus 40 transmits the collected usage history to the partial contents providing apparatus 10 (S403). Based on the transmitted usage history, the partial contents providing apparatus 10 monitors the usage history (S404), and generates partial contents for contents requiring abstraction of contents (S405). The partial contents providing apparatus receives a partial contents request signal from the second device (S406), and provides the generated partial contents to the second device that has requested the partial contents (S407).

FIGS. 3 and 4 provide exemplary embodiments of the partial contents providing system. The exemplary embodiment should not be construed as being limited to the exemplary embodiments.

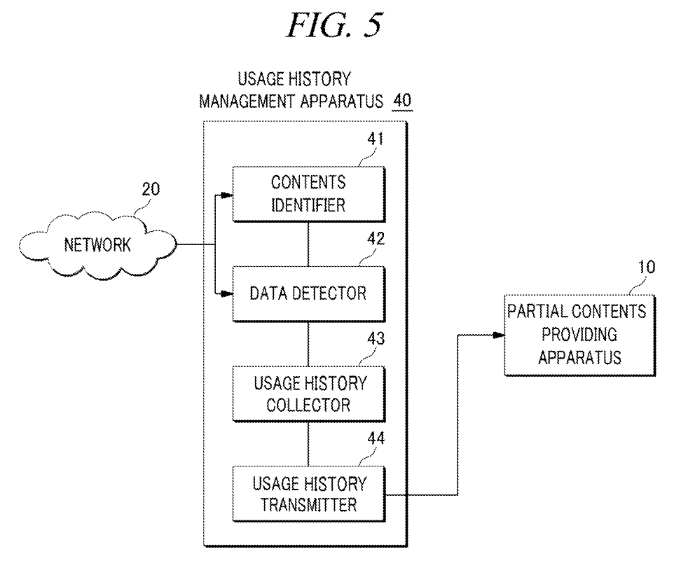

FIG. 5 is a block diagram illustrating a usage history management apparatus according to an exemplary embodiment. With reference to FIG. 5, the usage history management apparatus 40 for transmitting usage history of a device to the partial contents providing apparatus 10 includes a contents identifier 41, a data detector 42, a usage history collector 43, and a usage history transmitter 44. The usage history management apparatus may also include a memory and a central processing unit (CPU) for performing the operations described herein with respect the usage history management apparatus.

The contents identifier 41 identifies contents displayed on a first device among multiple devices. The data detector 42 can detect data transmitted to and received from a second device among the multiple devices.

The usage history collector 43 can collect usage history of the second device associated with the identified contents based on the detected data.

The usage history transmitter 44 may transmit the collected usage history to the partial contents providing apparatus. The transmitted usage history may be used to generate partial contents from contents.

The usage history management apparatus 40 illustrated in FIG. 5 performs the operation of the partial contents providing apparatus 10 illustrated in FIG. 1 to collect usage history of a device 300 from the device 300. Thus, the descriptions of the partial contents providing apparatus 10 illustrated in FIG. 1, even though the descriptions are omitted below, are applied to the operation of the usage history management apparatus 40 illustrated in FIG. 5. In other words, descriptions of the usage history management apparatus 40 of FIG. 5, which are not provided below, are identical to or can be easily understood by those skilled in the art from the descriptions of the operation of the partial contents providing apparatus 10 of FIG. 2 to collect usage history from multiple devices. Thus, descriptions of the usage history management apparatus 40 will be omitted.

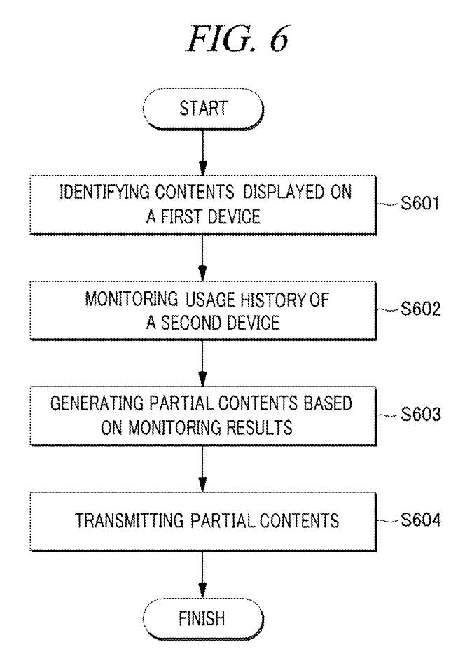

FIG. 6 is a flow diagram illustrating a partial contents providing method according to another exemplary embodiment. The method for providing partial contents according to an exemplary embodiment illustrated in FIG. 6 includes processes chronologically, or sequentially, performed in the partial contents providing apparatus 10 illustrated in FIG. 2. Accordingly, the descriptions of the partial contents providing apparatus 10 illustrated in FIG. 2, even though the descriptions are omitted below, are applied to the method for providing partial contents according to an exemplary embodiment illustrated in FIG. 6.

With reference to FIG. 6, the method of providing partial contents to the device 300 through the partial contents providing apparatus 10 comprises identifying contents displayed on a first device among multiple devices (S601), monitoring usage history of a second device among the multiple devices (S602), generating partial contents, which is a part of the contents, from the contents based on the monitored usage history (S603), and transmitting the partial contents to any one of the multiple devices (S604).

The exemplary embodiments may be embodied in a transitory or non-transitory storage medium which includes instruction codes which are executable by a computer or processor, such as a program module which is executable by the computer or processor. A data structure according to the exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of the exemplary embodiments is provided for the purpose of illustration, and it will be understood by those skilled in the art that various changes and modifications may be made without changing a technical conception and/or any essential features of the exemplary embodiments. Thus, the above-described exemplary embodiments are illustrative in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of the exemplary embodiments. It shall be understood that all modifications and embodiments conceived from the meaning and scope of the claims and their equivalents are included in the scope of the present inventive concept.

What is claimed is:

1. An apparatus comprising:
an identifier configured to identify contents displayed on a first device among a plurality of devices;
a monitor configured to monitor usage history of a second device among the plurality of devices;
a generator configured to generate partial contents, which are parts of the contents, based on the monitored usage history; and
a transmitter configured to transmit the partial contents to at least one device from among the plurality of devices.

2. The apparatus of claim 1, wherein at least two of the plurality of devices belong to a same user, and
the usage history of the second device is monitored during reproduction of the contents displayed on the first device.

3. The apparatus of claim 1, wherein the second device is located substantially close in proximity to the first device.

4. The apparatus of claim 3, wherein the usage history is monitored by using at least one from among data input to the second device and data output from the second device.

5. The apparatus of claim 1, wherein the usage history comprises a variation of a data usage amount associated with a service provided to the second device.

6. The apparatus of claim 1, wherein the contents comprises broadcasting stream contents, and
the usage history of the second device comprises at least one from among: one of an increasing history and decreasing history of social network service (SNS) data; one of an increasing history and decreasing history of message data; one of an increasing history and decreasing history of call data; and one of an increasing and decreasing history of keyword search data.

7. The apparatus of claim 1, wherein the partial contents is extracted from the contents starting at an extraction start time, and
the partial contents comprises information about the extraction start time.

8. The apparatus of claim 1, wherein the usage history comprises user comments associated with the contents.

9. The apparatus of claim 8, wherein the partial contents is generated based on at least one from among a time point when the user comments increase, a time point when the user comments reach a maximum amount, and a time point when the user comments decrease.

10. The apparatus of claim 8, wherein the partial contents is generated depending on whether the user comments are one from among favorable and unfavorable.

11. The apparatus of claim 8, wherein the partial contents comprises the user comments.

12. The apparatus of claim 1, wherein the transmitter is further configured to receive a request signal from one device of the plurality of devices, and transmit the partial contents to said one device.

13. The apparatus of claim 12, wherein the transmitter is further configured to select at least one from among a plurality of partial contents based on a type of said one device, and transmit the selected at least one from among the plurality of partial contents to said one device.

14. The apparatus of claim 13, wherein the selected at least one from among the plurality of partial contents comprises ranking information of the selected at least one from among the plurality of partial contents.

15. The apparatus of claim 12, wherein the transmitter is configured to further transmit, to said one device, recommended contents associated with one from among the contents and the partial contents.

16. The apparatus of claim 2, wherein the transmitter is further configured to transmit the partial contents to another device whose owner is different from the same user.

17. The apparatus of claim 1, wherein the monitor is further configured to receive usage history of the second device from a usage history management apparatus.

18. A method for transmitting contents to a device, the method comprising:
identifying contents displayed on a first device among a plurality of devices;
monitoring usage history of a second device among the plurality of devices;
generating partial contents, which is a part of the contents, based on the monitored usage history; and
transmitting the partial contents to at least one from among the plurality of devices.

19. An apparatus comprising:
an identifier configured to identify contents displayed on a first device among a plurality of devices;
a detector configured to detect data transmitted to and received from a second device among the plurality of devices;
a collector configured to collect usage history of the second device associated with the identified contents based on the detected data; and
a transmitter configured to transmit the collected usage history to a contents providing apparatus,
wherein the transmitted usage history is used for generating partial contents from the contents.

20. The apparatus of claim 17, wherein the usage history management apparatus is provided one of separate from or within the apparatus.

21. The apparatus of claim 10, wherein partial contents related to favorable user comments are different in color from partial contents related to unfavorable user comments.

22. The method according to claim 18, wherein the operations of identifying, monitoring, generating, and transmitting are sequentially performed in order.

23. The apparatus of claim 5, wherein the service is preset.

24. The apparatus of claim 12, wherein the request signal comprises a request for the partial contents.

25. A system for providing contents and partial contents, the system comprising:
a first device for providing partial contents to a receiving device, the first device comprising:
a monitor configured to monitor usage history of a second device among the plurality of devices; and
a generator configured to generate the partial contents, which is a part of the contents, based on the monitored usage history; and
a second device comprising:
an identifier configured to identify contents displayed on a first user device among a plurality of user devices; and
a detector configured to detect data transmitted to and received from a second user device among the plurality of user devices.
